(19) United States
(12) Patent Application Publication
(10) Pub. No.: US 2026/0307851 A1
(43) Pub. Date: Oct. 8, 2026

(54) DIVIDER CONSTRUCT FOR TRAYS, RELATED SYSTEMS AND METHODS

(71) Applicant: Graphic Packaging International, LLC, Atlanta, GA (US)

(72) Inventor: Lee Nowak, Leicestershire (GB)

(21) Appl. No.: 19/640,776

(22) Filed: Apr. 7, 2026

Related U.S. Application Data
(60) Provisional application No. 63/785,248, filed on Apr. 8, 2025.

(51) Int. Cl. B65D 5/49; B31B 50/26; B65D 5/28

(52) U.S. Cl. CPC B65D 5/48034; B31B 50/26; B65D 5/28

(57) ABSTRACT

A construct for forming divider features in an interior of a tray may include a first divider portion including a first plurality of divider panels, a second divider portion including a second plurality of divider panels, and a connector panel extending between the first divider portion and the second divider portion. The construct is secured within the interior of the tray using one or more attachment features.

### CROSS-REFERENCE TO RELATED APPLICATION

The present application claims priority to U.S. Provisional Patent Application No. 63/785,248 filed on Apr. 8, 2025.

### INCORPORATION BY REFERENCE

The disclosure of U.S. Provisional Patent Application No. 63/785,248, filed on April 8, 2025, is hereby incorporated by reference for all purposes as if presented herein in its entirety.

### TECHNICAL FIELD

The present disclosure relates to containers for at least one article. In some embodiments, the present disclosure relates to constructs for providing divider features in the interior of a tray for holding at least one article.

### BACKGROUND

Trays may be used to hold one or more articles, including food products and other retail items. Such trays may be used in customer service environments, including quick service restaurants and similar vendor settings. In some applications, a tray may hold multiple different articles simultaneously. It may be desirable to provide articles held in a tray in at least partial separation from one another. For example, separation of articles may be desirable to avoid commingling of different food products, to facilitate ease of service or use, or to more prominently display different articles to a customer.

### SUMMARY OF THE DISCLOSURE

According to one aspect, a construct for forming divider features in an interior of a tray may comprise a first divider portion including a first plurality of divider panels, a second divider portion including a second plurality of divider panels, and a connector panel extending between the first divider portion and the second divider portion.

In some embodiments, the connector panel may include attachment features that secure the construct to the tray. The first divider portion may include a first divider panel connected to a second divider panel via first and second side panels. The second divider panel may include a first divider panel portion attached in face-to-face contact to a second divider panel portion. The second divider portion may include a third divider panel connected to a fourth divider panel via third and fourth side panels. The third divider panel may include a third divider panel portion attached in face-to-face contact to a fourth divider panel portion. The connector panel may include a first panel portion in face-to-face contact to a second panel portion. The connector panel may be arranged to be in face-to-face arrangement with a bottom panel of the tray.

In some embodiments, the construct may form five separate compartments in the tray including a first compartment extending from an end panel of the tray to a first divider panel of the first divider portion and a second compartment extending from the first divider panel of the first divider portion to a second divider panel of the first divider portion. The five separate compartments may further include a third compartment extending from the second divider panel of the first divider portion to a third divider panel of the second divider portion, a fourth compartment from the third divider panel of the second divider portion to a fourth divider panel of the second divider portion, and a fifth compartment from the fourth divider panel of the second divider portion to a second end panel of the tray.

According to another aspect, a blank for forming a construct for forming divider features in an interior of a tray may comprise a first divider portion including a first plurality of divider panels, a second divider portion including a second plurality of divider panels, and a connector panel extending between the first divider portion and the second divider portion.

In some embodiments, the connector panel of the blank may include attachment features configured to secure the construct to the tray when the blank is formed into the construct. The first divider portion of the blank may include a first divider panel foldably connected to a second divider panel via first and second side panels. The second divider panel may include a first divider panel portion attached in face-to-face contact to a second divider panel portion when the blank is formed into the construct. The second divider portion of the blank may include a third divider panel foldably connected to a fourth divider panel via third and fourth side panels. The third divider panel may include a third divider panel portion attached in face-to-face contact to a fourth divider panel portion when the blank is formed into the construct. The connector panel of the blank may include a first panel portion foldably connected to a second panel portion. The connector panel may be configured to be in face-to-face arrangement with a bottom panel of the tray when the blank is formed into the construct.

In some embodiments, the blank may be configured to form five separate compartments in the tray including a first compartment extending from an end panel of the tray to a first divider panel of the first divider portion and a second compartment extending from the first divider panel of the first divider portion to a second divider panel of the first divider portion. The five separate compartments may further include a third compartment extending from the second divider panel of the first divider portion to a third divider panel of the second divider portion, a fourth compartment from the third divider panel of the second divider portion to a fourth divider panel of the second divider portion, and a fifth compartment from the fourth divider panel of the second divider portion to a second end panel of the tray.

According to another aspect, a method of forming a construct for forming divider features in an interior of a tray may comprise forming a first divider portion including a first plurality of divider panels, forming a second divider portion including a second plurality of divider panels, and connecting the first divider portion to the second divider portion via a connector panel.

In some embodiments, the connector panel may include attachment features, and the method may further comprise securing the construct to the tray via the attachment features. Forming the first divider portion may comprise foldably connecting a first divider panel to a second divider panel via first and second side panels. Forming the first divider portion may further comprise attaching a first divider panel portion of the second divider panel in face-to-face contact with a second divider panel portion of the second divider panel. Forming the second divider portion may comprise foldably connecting a third divider panel to a fourth divider panel via third and fourth side panels. Forming the second divider portion may further comprise attaching a third divider panel portion of the third divider panel in face-to-face contact with a fourth divider panel portion of the third divider panel. The method may further comprise attaching a first panel portion of the connector panel in face-to-face contact with a second panel portion of the connector panel, and positioning the connector panel in face-to-face arrangement with a bottom panel of the tray.

In some embodiments, the method may further comprise forming five separate compartments in the tray including a first compartment extending from an end panel of the tray to a first divider panel of the first divider portion and a second compartment extending from the first divider panel of the first divider portion to a second divider panel of the first divider portion. Forming the five separate compartments may further comprise forming a third compartment extending from the second divider panel of the first divider portion to a third divider panel of the second divider portion, a fourth compartment from the third divider panel of the second divider portion to a fourth divider panel of the second divider portion, and a fifth compartment from the fourth divider panel of the second divider portion to a second end panel of the tray.

According to another aspect, a system may comprise a tray having an interior and a construct disposed in the interior of the tray, the construct comprising a first divider portion including a first plurality of divider panels, a second divider portion including a second plurality of divider panels, and a connector panel extending between the first divider portion and the second divider portion.

In some embodiments, the connector panel of the system may include attachment features that secure the construct to the tray. The first divider portion may include a first divider panel connected to a second divider panel via first and second side panels. The second divider panel may include a first divider panel portion attached in face-to-face contact to a second divider panel portion. The second divider portion of the system may include a third divider panel connected to a fourth divider panel via third and fourth side panels. The third divider panel may include a third divider panel portion attached in face-to-face contact to a fourth divider panel portion. The connector panel of the system may include a first panel portion attached in face-to-face contact to a second panel portion. The connector panel may be arranged in face-to-face arrangement with a bottom panel of the tray.

In some embodiments, the construct of the system may form five separate compartments in the tray including a first compartment extending from an end panel of the tray to a first divider panel of the first divider portion and a second compartment extending from the first divider panel of the first divider portion to a second divider panel of the first divider portion. The five separate compartments may further include a third compartment extending from the second divider panel of the first divider portion to a third divider panel of the second divider portion, a fourth compartment from the third divider panel of the second divider portion to a fourth divider panel of the second divider portion, and a fifth compartment from the fourth divider panel of the second divider portion to a second end panel of the tray.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank for forming a construct for forming divider features in a tray according to an embodiment of the disclosure.

FIG. 2 is a perspective view of a blank for forming the tray for at least partially receiving the construct shown in FIG. 1, according to embodiments of the present disclosure.

FIG. 3A is a perspective view of the tray formed from the blank shown in FIG. 2, the tray for at least partially receiving the construct according to embodiments of the present disclosure.

FIG. 3B is a perspective view of the construct formed from the blank shown in FIG. 1, the construct in a collapsed configuration according to embodiments of the present disclosure.

FIG. 4 is a top perspective view of the partially formed construct according to embodiments of the present disclosure.

FIG. 5 is a bottom perspective view of the partially formed construct according to embodiments of the present disclosure.

FIG. 6 is a bottom perspective view of the partially formed construct in a transitional state according to embodiments of the present disclosure.

FIG. 7 is a bottom perspective view of the fully formed construct according to embodiments of the present disclosure.

FIG. 8 is a top perspective view of the fully formed construct according to embodiments of the present disclosure.

FIG. 9 is a top perspective view of a system, the system including the construct formed from the blank in FIG. 1 and the tray formed from the blank in FIG. 2 according to embodiments of the present disclosure.

Corresponding parts are designated by corresponding reference numbers throughout the drawings.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques disclosed herein relate generally to constructs for forming divider features in an interior of a tray for holding one or more articles. More specifically, techniques disclosed herein relate to constructs including a first divider portion, a second divider portion, and a connector panel extending between the first divider portion and the second divider portion that may be received in a tray to form a plurality of compartments in the interior of the tray. Various embodiments may be described herein, including constructs, blanks for forming such constructs, systems including a construct and a tray, methods of forming constructs, and the like.

In order to better appreciate the features and aspects of the present disclosure, further context for the disclosure may be provided in the following section by discussing one particular implementation of a construct for forming divider features in an interior of a tray according to embodiments of the disclosure. These embodiments may be for explanatory purposes only and other embodiments may be employed in other packaging applications. For example, embodiments of the disclosure may be used with any tray or similar structure that receives, holds, stores, transports, displays, or serves one or more products. In some instances, embodiments of the disclosure may be particularly well suited for use with trays for food products, such as press-formed trays used in quick-service restaurant, food-service, catering, take-out, or retail food packaging environments, because of their potentially compact form factor and their compatibility with a divider construct that may be received in a tray without requiring modification of the tray's own manufacturing process.

The present disclosure relates to a divider construct that may be placed inside a tray to separate the interior of the tray into two or more distinct compartments. The construct may allow a single tray to hold several different items at the same time while keeping those items separated from one another. This may be useful, for example, when serving a meal that includes multiple different food items that a customer may prefer to keep apart.

The construct may be formed from a flat blank of material, such as paperboard, that may be folded and assembled into a three-dimensional structure. The blank may be folded along pre-scored lines to create a pair of divider portions, each of which may stand upright inside the tray to provide walls that separate adjacent compartments. The two divider portions may be connected to one another by a connector portion that may lie flat against the bottom of the tray and help hold the construct in place.

Once assembled and placed in the tray, the construct may divide the interior of the tray into multiple separate compartments arranged side by side. The construct may be secured to the tray so that it does not shift during use. Because the construct may be formed separately from the tray, it may be combined with the tray when needed and removed or discarded independently of the tray.

Various aspects of the disclosure may be understood further by referring to the figures. For purposes of simplicity, like numerals may be used to describe like features. It will be understood that where a plurality of similar features are depicted, not all of such features necessarily are labeled on each figure. It also will be understood that the various components used to form the constructs may be interchanged. Thus, while only certain combinations are illustrated herein, numerous other combinations and configurations are contemplated hereby.

Containers and constructs according to the present disclosure can accommodate articles of numerous different shapes. In this specification, the terms “lower,” “bottom,” “upper,” “top,” “front,” and “back” indicate orientations determined in relation to fully erected containers and constructs. As described herein, containers and constructs may be formed by multiple overlapping panels, portions, and/or end flaps. Such panels, portions, and/or end flaps may be designated in relative terms to one another, e.g., “first”, “second”, “third”, etc., in sequential or non-sequential reference, without departing from the disclosure.

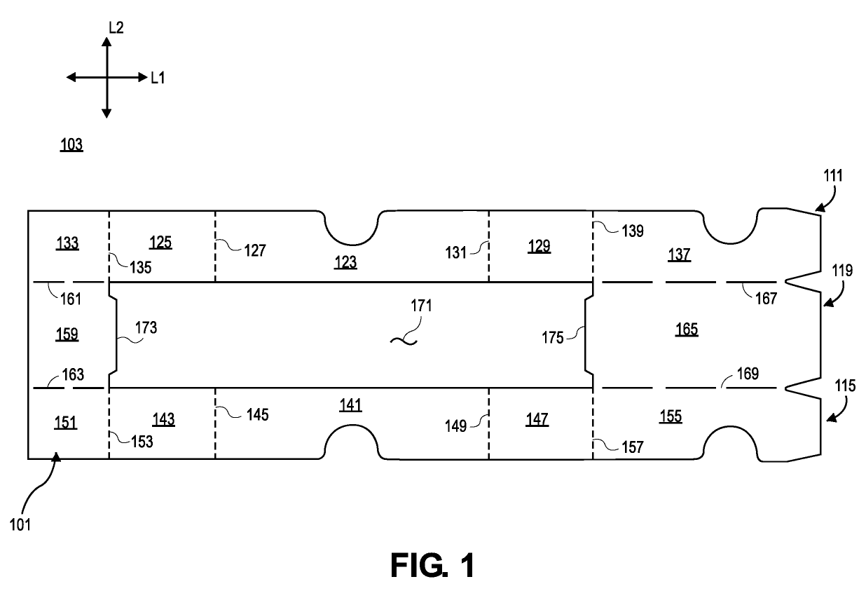

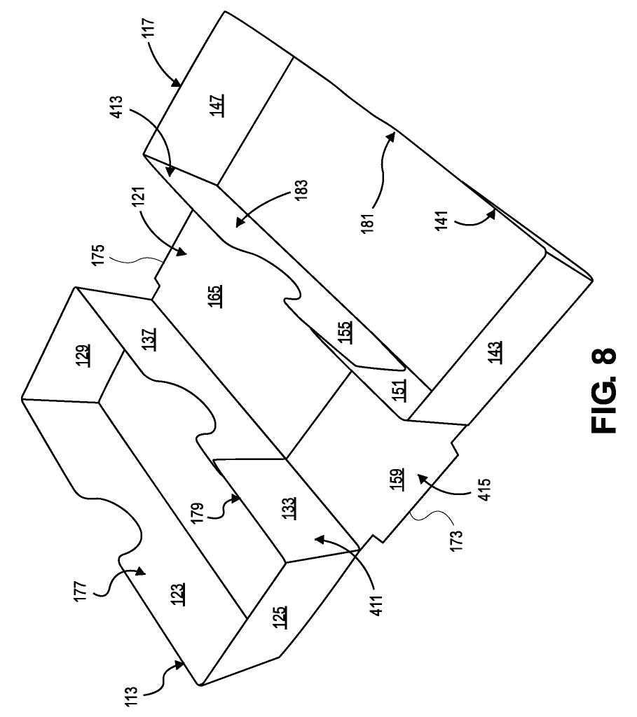

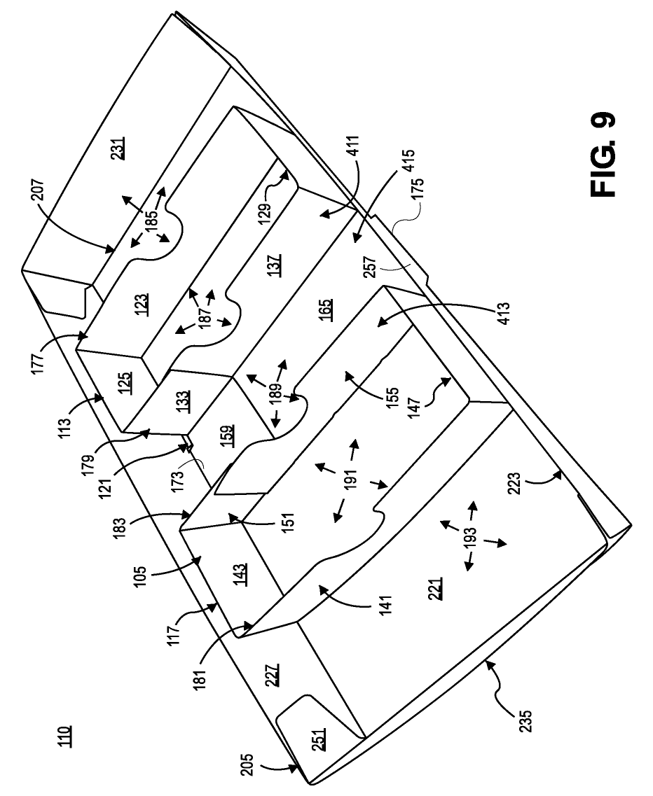

According to an embodiment of the disclosure, FIG. 1 illustrates an exterior surface 101 of a blank 103 for forming a divider construct or construct 105 (FIG. 8) according to embodiments of the disclosure. The construct 105 can be configured to form a divider insert, to provide divider features in the interior of another container such as a tray or other container. In this regard, the construct 105 can be provided together with the tray or other container to form a system 110 (FIG. 9).

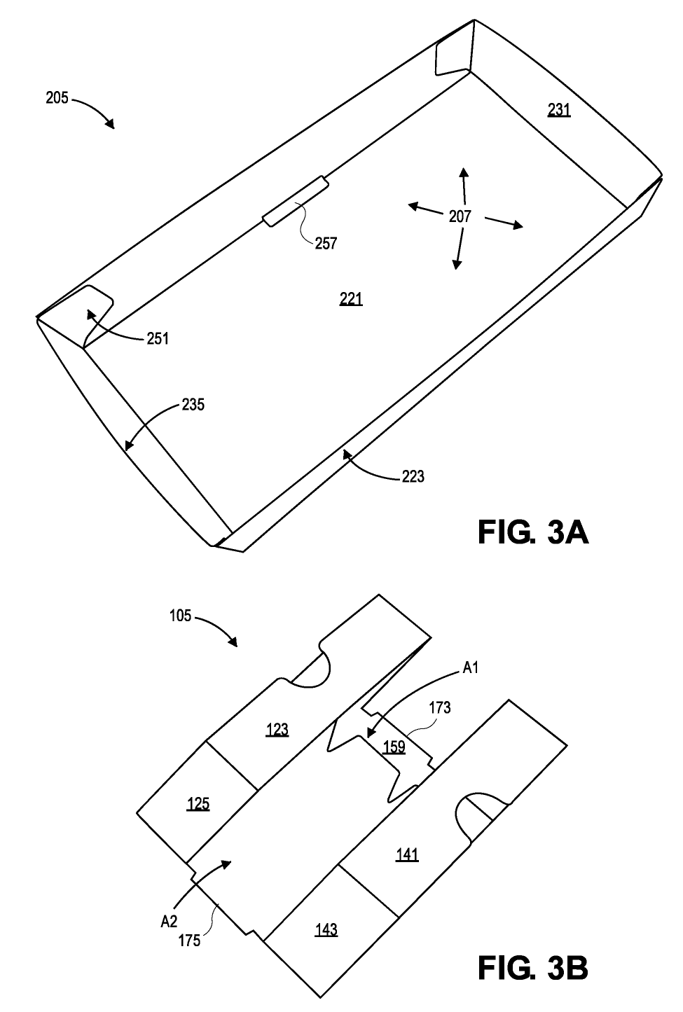

With momentary reference to FIG. 3A, a tray 205 for use with the construct 105 according to embodiments of the present disclosure is schematically illustrated. The tray 205 can include a plurality of panels including a bottom panel in addition to side panels and end panels that extend upwardly from the bottom panel such that the plurality of panels of the tray 205 extend at least partially around an interior of the tray 205 for at least partially receiving the construct 105.

Trays (e.g., trays or other containers) that can be used to form the system 110, can be used for holding one or more articles such as food products, e.g., portioned retail food products, that can include one or more of cookies, crackers, cakes, pastries, candies, nuts, popcorn, trail mix, gum, etc. In some embodiments, the articles can include frozen or non-frozen food products that can be provided in discrete portions, for example, chicken nuggets, French fries, onion rings, mozzarella sticks, chips, popcorn, other finger foods, etc. In embodiments, other types of articles that can include food products and/or non-food products can be placed in a tray for service to a customer, for example, at a quick service restaurant or vendor. In some embodiments, such products can be contained in additional packaging and then placed in a tray. Such trays could be otherwise shaped and arranged and could be used to hold other products and/or articles in similar or different environments without departing from the disclosure.

With continued reference to FIG. 1, the blank 103 has a longitudinal axis L1 and a lateral axis L2. It will be understood that the axes L1, L2 could be transposed or otherwise oriented without departing from the disclosure. The blank 103 can have a plurality of panels arranged across a first divider portion 111 for forming a first construct divider portion 113 of the construct 105/system 110, a second divider portion 115 of the blank 103 for forming a second construct divider portion 117 of the construct 105/system 110, and a connector portion 119 of the blank 103 for forming a construct connector portion 121 of the construct 105/system 110 extending from the first construct divider portion 113 to the second construct divider portion 117. The first divider portion 111 of the blank 103/first construct divider portion 113 of the construct 105/system 110 can be foldably connected to the second divider portion 115 of the blank 103/second construct divider portion 117 of the construct 105/system 110 via the connector portion 119/construct connector portion 121.

The first divider portion 111 of the blank 103/first construct divider portion 113 of the construct 105 can include a first plurality of divider panels that include a first divider panel 123 (broadly, “second divider panel”, “third divider panel”, “fourth divider panel”, “fifth divider panel”) foldably connected to a first side panel 125 (broadly, “second side panel”, “third side panel”, “fourth side panel”, “fifth side panel”) at a lateral fold line 127, the first divider panel 123 foldably connected to a second side panel 129 (broadly, “first side panel”, “third side panel”, “fourth side panel”, “fifth side panel”) at a lateral fold line 131. The first side panel 125 can be foldably connected to a first divider panel portion 133 (broadly, “second divider panel portion”, “third divider panel portion”, “fourth divider panel portion”) at a lateral fold line 135, and the second side panel 129 can be foldably connected to a second divider panel portion 137 (broadly, “first divider panel portion”, “third divider panel portion”, “fourth divider panel portion”, “fifth divider panel portion”) at a lateral fold line 139.

Similarly, the second divider portion 115 of the blank 103/second construct divider portion 117 of the construct 105 can include a second plurality of divider panels that include a second divider panel 141 (broadly, “first divider panel”, “third divider panel”, “fourth divider panel”, “fifth divider panel”) foldably connected to a third side panel 143 (broadly, “first side panel”, “second side panel”, “fourth side panel”, “fifth side panel”) at a lateral fold line 145, the second divider panel 141 foldably connected to a fourth side panel 147 (broadly, “first side panel”, “second side panel”, “third side panel”, “fifth side panel”) at a lateral fold line 149. The third side panel 143 can be foldably connected to a third divider panel portion 151 (broadly, “first divider panel portion”, “second divider panel portion”, “fourth divider panel portion”, “fifth divider panel portion”) at a lateral fold line 153, and the fourth side panel 147 can be foldably connected to a fourth divider panel portion 155 (broadly, “first divider panel portion”, “second divider panel portion”, “third divider panel portion”, “fifth divider panel portion”) at a lateral fold line 157.

With continued reference to FIG. 1, the connector portion 119 of the blank 103/construct connector portion 121 of the construct 105 can include a first panel portion 159 foldably connected to the first divider panel portion 133 at a longitudinal fold line 161 and foldably connected to the third divider panel portion 151 at a longitudinal fold line 163. A second panel portion 165 can be foldably connected to the second divider panel portion 137 at a longitudinal fold line 167 and can be foldably connected to the fourth divider panel portion 155 at a longitudinal fold line 169.

As shown, a cutout 171 can be positioned between the panel portions 159, 165. In this regard, a locking tab 173 can be at least partially formed along a free edge of the first panel portion 159 so as to protrude away from a remainder thereof into the cutout 171. Similarly, a locking tab 175 can be at least partially formed along a free edge of the second panel portion 165 so as to protrude away from a remainder thereof into the cutout 171.

As shown, one or more of the divider panels (e.g., divider panels 123, 141, divider panel portions 137, 155, etc.) can be formed with a recessed feature at least partially along a free edge thereof, such that when the formed construct 105 is placed in the tray 205, recessed features can assist with removal of articles, providing users with openings in divider panels for contacting sides of articles. It will be understood that one or more of the panels of the construct 105 can have a different configuration without departing from the disclosure.

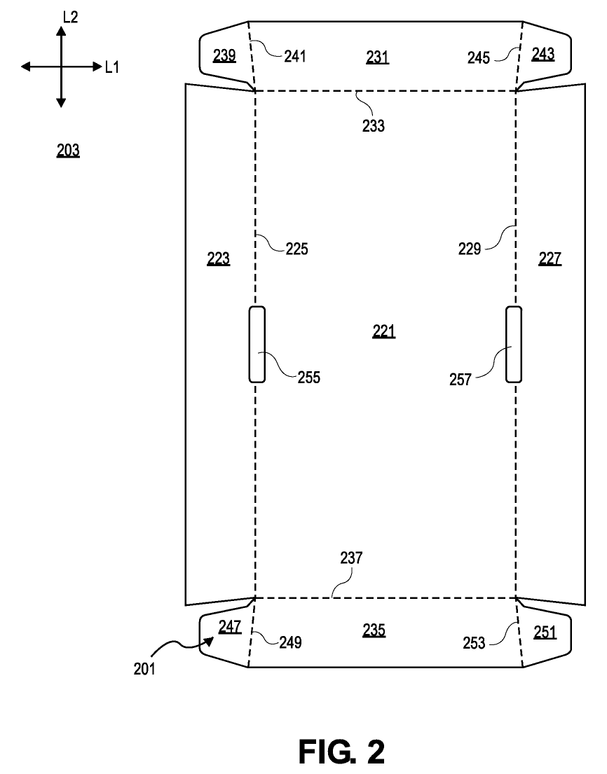

Turning to FIG. 2, a blank 203 for forming the tray 205 for at least partially receiving the construct 105 and forming the system 110 is illustrated. As shown, the blank 203 can include a lateral axis L1, a longitudinal axis L2, and a plurality of panels for at least partially extending around an interior 207 of the tray 205. It will be understood that the axes L1, L2 could be transposed or otherwise oriented without departing from the disclosure.

In the illustrated embodiment, the plurality of panels of the blank 203/tray 205 can include a bottom panel 221, a first tray side panel 223 foldably connected to the bottom panel 221 at a longitudinal fold line 225, a second tray side panel 227 foldably connected to the bottom panel 221 at a longitudinal fold line 229, a first end panel 231 foldably connected to the bottom panel 221 at a lateral fold line 233, and a second end panel 235 foldably connected to the bottom panel 221 at a lateral fold line 237.

A plurality of end flaps can be foldably connected to a respective panel of the plurality of panels, and can include a first attachment end flap 239 foldably connected to the first end panel 231 at an oblique fold line 241, a second attachment end flap 243 foldably connected to the first end panel 231 at an oblique fold line 245, a third attachment end flap 247 foldably connected to the second end panel 235 at an oblique fold line 249, and a fourth attachment end flap 251 foldably connected to the second end panel 235 at an oblique fold line 253.

As also shown, the blank 203 and tray 205 formed therefrom can include a locking opening 255 interrupting the fold line 225, and a locking opening 257 interrupting the fold line 229. As described herein, the locking openings 255, 257 can be for at least partially receiving the locking tabs 173, 175 of the blank 103/construct 105, in the specified or the reverse order, such that the locking tabs 173, 175 and locking openings 255, 257 can be locking features thereof and of the system 110.

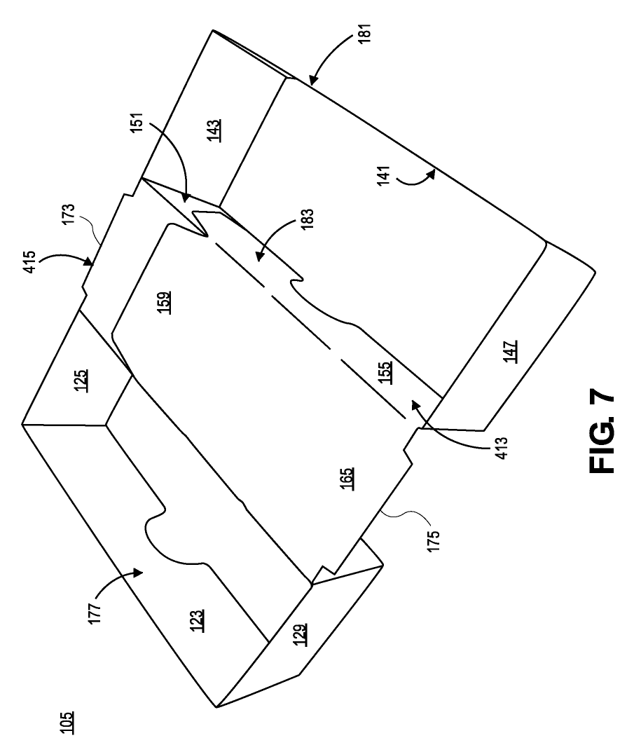

With additional reference to FIGS. 3A-9, formation of the construct 105 from the blank 103, formation of the tray 205 from the blank 203, and formation of the system 110 will be described according to an embodiment of the disclosure.

In the illustrated embodiment, the blank 103 can be inverted, e.g., such that the exterior surface 101 thereof is positioned on a supporting surface and such that the interior surface thereof, e.g., the surface planarly opposite the exterior surface 101, is positioned facing upwardly.

As shown in FIG. 3B, the first divider panel portion 133 and the third divider panel portion 151 can be folded at the respective fold lines 135, 153 in the direction of the arrow A1 and such that the first panel portion 159 is carried in the direction of arrow A1 toward the cutout 171. Similarly, the second divider panel portion 137 and the fourth divider panel portion 155 can be folded at the respective fold lines 139, 157 in the direction of arrow A2 such that the second panel portion 165 is carried in the direction of the arrow A2.

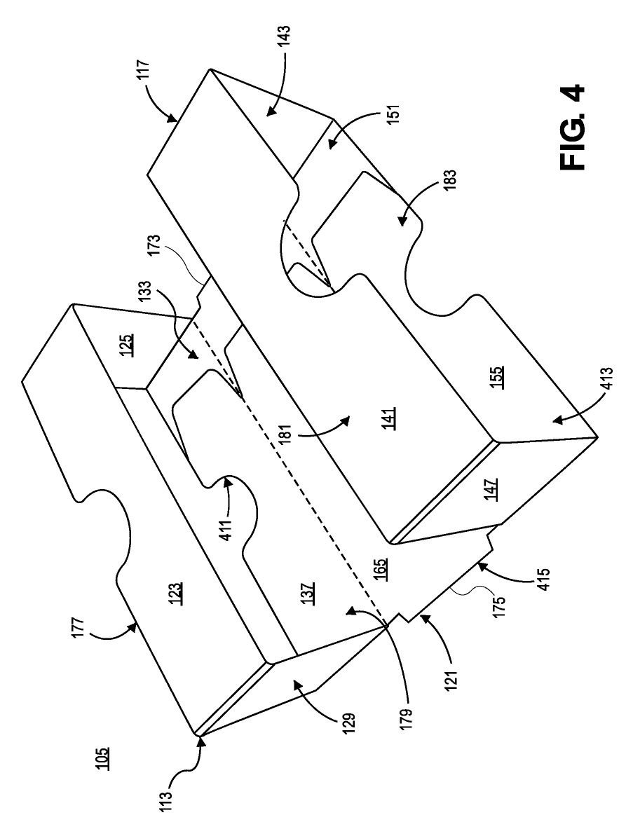

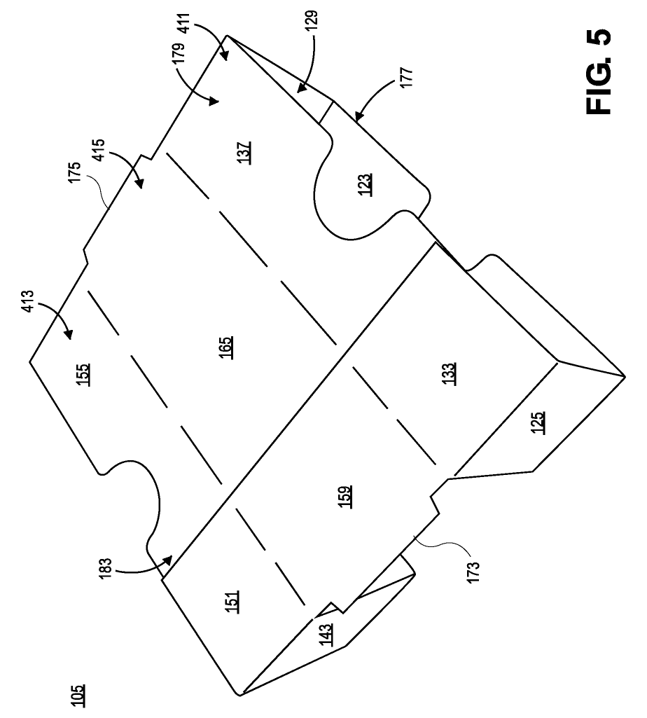

Referring to FIGS. 4-5, the aforementioned movement of panels can be such that the first divider panel portion 133 is positioned in at least partial face-to-face contact with the second divider panel portion 137, forming a third divider panel 411 (broadly, “first divider panel”, “second divider panel”, “fourth divider panel”, “fifth divider panel”). Similarly, the third divider panel portion 151 is positioned in at least partial face-to-face contact with respective portions of the fourth divider panel portion 155, forming a fourth divider panel 413 (broadly, “first divider panel”, “second divider panel”, “third divider panel”, “fifth divider panel”). Furthermore, the second panel portion 165 can be positioned in at least partial face-to-face contact with the first panel portion 159, forming a connector panel 415. In some embodiments, such arrangement can be at least partially maintained with one or more applications of an adhesive such as glue.

The first side panel 125 and the second side panel 129 can be positioned opposite one another in generally spaced and perpendicular relation with the first divider panel 123 and the third divider panel 411 extending therebetween. Similarly, the third side panel 143 and the fourth side panel 147 can be positioned opposite one another in generally spaced and perpendicular relation with the second divider panel 141 and the fourth divider panel 413 extending therebetween.

The first divider panel 123 can thus form a first divider wall 177 of the first construct divider portion 113 of the construct 105, the third divider panel 411 can form a second divider wall 179 of the first construct divider portion 113 (broadly, “first plurality of divider walls of the first divider portion”). The second divider panel 141 can form a third divider wall 181 of the second construct divider portion 117, and the fourth divider panel 413 can form a fourth divider wall 183 of the second construct divider portion 117 (broadly, “second plurality of divider walls of the second divider portion”).

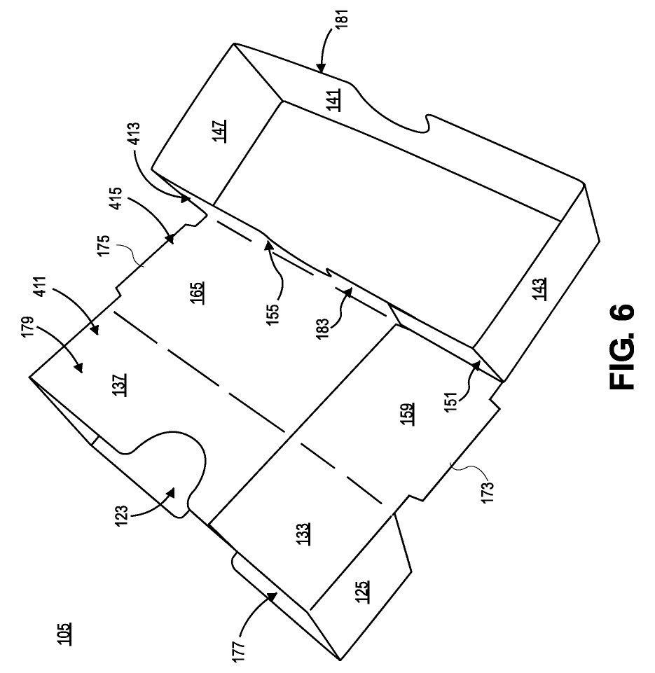

As illustrated in FIG. 6, the second divider wall 179 of the first construct divider portion 113 can be folded at respective collinear fold lines 161, 167 to extend in generally perpendicular relation from the connector panel 415. Similarly, the fourth divider wall 183 of the second construct divider portion 117 can be folded at respective collinear fold lines 163, 169 to extend in generally perpendicular relation from the connector panel.

In order to form the tray 205, the blank 203 (FIG. 2) can be inverted, e.g., such that the exterior surface 201 thereof is positioned on a supporting surface and such that the interior surface thereof, e.g., the surface planarly opposite the exterior surface 201, is positioned facing upwardly.

The first tray side panel 223 can be at least partially folded at the fold line 225 into generally upright relation with the bottom panel 221, e.g., so as to be in perpendicular or oblique relation thereto, the second tray side panel 227 can be at least partially folded at the fold line 229 into generally upright relation with the bottom panel 221, the first end panel 231 can be at least partially folded at the fold line 233 into generally upright relation with the bottom panel 221, and the second end panel 235 can be at least partially folded at the fold line 237 into generally upright relation with the bottom panel 221.

In such an arrangement, the attachment end flaps 239, 247 can be at least partially folded at the respective fold lines 241, 249 and positioned in at least partial face-to-face contact with respective portions of the first tray side panel 223, and the attachment end flaps 243, 251 can be at least partially folded at the fold lines 245, 253 into at least partial face-to-face contact with respective portions of the second tray side panel 227. Such positioning can be at least partially maintained with one or more applications of an adhesive such as glue.

Such formed configuration of the tray 205 can provide the interior 207 (FIG. 3A) thereof for at least partially receiving the construct 105. In the illustrated embodiment, the connector panel 415 (FIG. 8) of the construct 105 can be positioned in at least partial face-to-face contact with the bottom panel 221 of the tray 205. Such an arrangement positions the divider walls 177, 179, 181, 183 of the construct 105 in generally upstanding relation with the connector panel 415 of the construct 105 and with the bottom panel 221 of the tray 205. The side panels 125, 143 can be positioned adjacent and/or in at least partial face-to-face contact with the second tray side panel 227 and the side panels 129, 147 can be positioned adjacent and/or in at least partial face-to-face contact with the first tray side panel 223, though it will be understood that the construct 105 can be positioned in a different orientation with respect to the tray 205 without departing from the disclosure. For example, the side panels can extend vertically to form an acute angle with the second tray side panel 227. Similarly, the side panels 129, 147 can extend vertically to form an acute angle with the first tray side panel 223.

The position of the construct 105 in the interior 207 of the tray 205 can be at least partially maintained via at least partial insertion of the locking tabs 173, 175 of the construct 105 through the locking openings 255, 257 (or the insertion of the locking tabs 173, 175 through the respective locking openings 257, 255, as the case may be). Such engagement of the locking features can, for example, maintain integrity of the system 110 by avoiding incidental/inadvertent disengagement of the construct 105 and the tray 205, avoid shifting of the construct 105 in the interior 207 of the tray 205, etc.

In the aforementioned arrangement, in which the construct 105 is at least partially received in the interior 207 of the tray 205, a first compartment 185 (broadly, “second compartment” or “third compartment” or “fourth compartment” or “fifth compartment”) can be at least partially defined in the interior 207 of the tray 205 between the first divider wall 177 of the construct 105 and the first end panel 231 of the tray 205 (or the second end panel 235 of the tray 205, as the case may be). A second compartment 187 (broadly, “first compartment” or “third compartment” or “fourth compartment” or “fifth compartment”) can be at least partially defined in the interior 207 of the tray 205 between the first divider wall 177 of the construct 105 and the second divider wall 179 of the construct 105. A third compartment 189 (broadly, “first compartment” or “second compartment” or “fourth compartment” or “fifth compartment”) can be at least partially defined in the interior 207 of the tray 205 between the second divider wall 179 of the construct 105 and the third divider wall 181 of the construct 105, e.g., so as to be at least partially defined across the connector portion 119 of the construct 105. A fourth compartment 191 (broadly, “first compartment” or “second compartment” or “third compartment” or “fifth compartment”) can be at least partially defined in the interior 207 of the tray 205 between the third divider wall 181 of the construct 105 and the fourth divider wall 183 of the construct 105. A fifth compartment 193 (broadly, “first compartment” or “second compartment” or “third compartment” or “fourth compartment”) can be at least partially defined in the interior 207 of the tray 205 between the fourth divider wall 183 of the construct 105 and the second end panel 235 of the tray 205 (or the first end panel 231 of the tray 205, as the case may be).

Such provision for compartments 185, 187, 189, 191, 193 within the interior 207 of the tray 205 provides the system 110 with a configuration such that respective portions of the interior 207 of the tray 205 can be at least partially maintained in separation, e.g., to provide separated receiving spaces for articles or products in the system 110. For example, different types of food products could be held in different compartments in the interior 207 of the tray 205, food products and accessories therefore (e.g., different cake bar flavors, dressings, etc.) could be held in different compartments in the interior 207 of the tray 205, pre-portioning of food products can be provided by such compartmentalization of the interior 207 of the tray 205, etc.

The enhanced capability of a compartmented interior space provided in the tray 205 by the construct 105 of the system 110 is thus accomplished with the construct 105 that can be separately formed from the tray 205 (or another tray) so as to be selectively positionable with regard to the tray 205, providing a manufacturer, point of service, or user with selection regarding the ability to compartmentalize the interior of a tray, to offer such capability selectively, to dispose of the construct 105 and the tray 205 separately, etc. The construct 105 is also provided in an easy to form and easy to store/transport profile, for example, a generally collapsed or flattened configuration that can be further erected on site.

It will be understood that blanks and trays according to the present disclosure can have a different number, arrangement, and/or configuration of features without departing from the disclosure.

In general, the blanks described herein may be constructed from paperboard having a caliper so that it is heavier and more rigid than ordinary paper. The blanks can also be constructed of other materials, such as cardboard, sheet plastics or any other material having properties suitable for enabling the container to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various embodiments. Various additions, modifications, changes, etc., could be made to the embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A construct for forming divider features in an interior of a tray, the construct comprising:
a first divider portion including a first plurality of divider panels;
a second divider portion including a second plurality of divider panels; and
a connector panel extending between the first divider portion and the second divider portion.

2. The construct of claim 1, wherein the connector panel includes attachment features that secure the construct to the tray.

3. The construct of claim 1, wherein the first divider portion includes a first divider panel connected to a second divider panel via first and second side panels.

4. The construct of claim 3, wherein the second divider panel includes a first divider panel portion attached in face-to-face contact to a second divider panel portion.

5. The construct of claim 1, wherein the second divider portion includes a third divider panel connected to a fourth divider panel via third and fourth side panels.

6. The construct of claim 5, wherein the third divider panel includes a third divider panel portion attached in face-to-face contact to a fourth divider panel portion.

7. The construct of claim 1, wherein the connector panel includes a first panel portion in face-to-face contact with a second panel portion.

8. The construct of claim 1, wherein the connector panel is arranged to be in face-to-face arrangement with a bottom panel of the tray.

9. The construct of claim 1, wherein the construct forms five separate compartments in the tray including a first compartment extending from an end panel of the tray to a first divider panel of the first divider portion and a second compartment extending from the first divider panel of the first divider portion to a second divider panel of the first divider portion.

10. The construct of claim 9, wherein the five separate compartments in the tray further include a third compartment extending from the second divider panel of the first divider portion to a third divider panel of the second divider portion, a fourth compartment from the third divider panel of the second divider portion to a fourth divider panel of the second divider portion, and a fifth compartment from the fourth divider panel of the second divider portion to a second end panel of the tray.

11. A blank for forming a construct for forming divider features in an interior of a tray, the blank comprising:
a first divider portion including a first plurality of divider panels;
a second divider portion including a second plurality of divider panels; and
a connector panel extending between the first divider portion and the second divider portion.

12. The blank of claim 11, wherein the connector panel includes attachment features configured to secure the construct to the tray when the blank is formed into the construct.

13. The blank of claim 11, wherein the first divider portion includes a first divider panel foldably connected to a second divider panel via first and second side panels.

14. The blank of claim 13, wherein the second divider panel includes a first divider panel portion attached in face-to-face contact to a second divider panel portion when the blank is formed into the construct.

15. The blank of claim 11, wherein the second divider portion includes a third divider panel foldably connected to a fourth divider panel via third and fourth side panels.

16. The blank of claim 15, wherein the third divider panel includes a third divider panel portion attached in face-to-face contact to a fourth divider panel portion when the blank is formed into the construct.

17. The blank of claim 11, wherein the connector panel includes a first panel portion foldably connected to a second panel portion.

18. The blank of claim 11, wherein the connector panel is configured to be in face-to-face arrangement with a bottom panel of the tray when the blank is formed into the construct.

19. The blank of claim 11, wherein the blank is configured to form five separate compartments in the tray including a first compartment extending from an end panel of the tray to a first divider panel of the first divider portion and a second compartment extending from the first divider panel of the first divider portion to a second divider panel of the first divider portion.

20. The blank of claim 19, wherein the five separate compartments further include a third compartment extending from the second divider panel of the first divider portion to a third divider panel of the second divider portion, a fourth compartment from the third divider panel of the second divider portion to a fourth divider panel of the second divider portion, and a fifth compartment from the fourth divider panel of the second divider portion to a second end panel of the tray.

21. A method of forming a construct for forming divider features in an interior of a tray, the method comprising:
forming a first divider portion including a first plurality of divider panels;
forming a second divider portion including a second plurality of divider panels; and
connecting the first divider portion to the second divider portion via a connector panel.

22. The method of claim 21, wherein the connector panel includes attachment features, and wherein the method further comprises securing the construct to the tray via the attachment features.

23. The method of claim 21, wherein forming the first divider portion comprises foldably connecting a first divider panel to a second divider panel via first and second side panels.

24. The method of claim 23, wherein forming the first divider portion further comprises attaching a first divider panel portion of the second divider panel in face-to-face contact with a second divider panel portion of the second divider panel.

25. The method of claim 21, wherein forming the second divider portion comprises foldably connecting a third divider panel to a fourth divider panel via third and fourth side panels.

26. The method of claim 25, wherein forming the second divider portion further comprises attaching a third divider panel portion of the third divider panel in face-to-face contact with a fourth divider panel portion of the third divider panel.

27. The method of claim 21, further comprising attaching a first panel portion of the connector panel in face-to-face contact with a second panel portion of the connector panel.

28. The method of claim 21, further comprising positioning the connector panel in face-to-face arrangement with a bottom panel of the tray.

29. The method of claim 21, further comprising forming five separate compartments in the tray including a first compartment extending from an end panel of the tray to a first divider panel of the first divider portion and a second compartment extending from the first divider panel of the first divider portion to a second divider panel of the first divider portion.

30. The method of claim 29, wherein forming the five separate compartments further comprises forming a third compartment extending from the second divider panel of the first divider portion to a third divider panel of the second divider portion, a fourth compartment from the third divider panel of the second divider portion to a fourth divider panel of the second divider portion, and a fifth compartment from the fourth divider panel of the second divider portion to a second end panel of the tray.

31. A system comprising:
a tray having an interior; and
a construct disposed in the interior of the tray, the construct comprising a first divider portion including a first plurality of divider panels, a second divider portion including a second plurality of divider panels, and a connector panel extending between the first divider portion and the second divider portion.

32. The system of claim 31, wherein the connector panel includes attachment features that secure the construct to the tray.

33. The system of claim 31, wherein the first divider portion includes a first divider panel connected to a second divider panel via first and second side panels.

34. The system of claim 33, wherein the second divider panel includes a first divider panel portion attached in face-to-face contact to a second divider panel portion.

35. The system of claim 31, wherein the second divider portion includes a third divider panel connected to a fourth divider panel via third and fourth side panels.

36. The system of claim 35, wherein the third divider panel includes a third divider panel portion attached in face-to-face contact to a fourth divider panel portion.

37. The system of claim 31, wherein the connector panel includes a first panel portion attached in face-to-face contact to a second panel portion.

38. The system of claim 31, wherein the connector panel is arranged in face-to-face arrangement with a bottom panel of the tray.

39. The system of claim 31, wherein the construct forms five separate compartments in the tray including a first compartment extending from an end panel of the tray to a first divider panel of the first divider portion and a second compartment extending from the first divider panel of the first divider portion to a second divider panel of the first divider portion.

40. The system of claim 39, wherein the five separate compartments further include a third compartment extending from the second divider panel of the first divider portion to a third divider panel of the second divider portion, a fourth compartment from the third divider panel of the second divider portion to a fourth divider panel of the second divider portion, and a fifth compartment from the fourth divider panel of the second divider portion to a second end panel of the tray.
